(19) United States
(12) Patent Application Publication
(10) Pub. No.: US 2006/0215495 A1
(43) Pub. Date: Sep. 28, 2006

(54) Automated programmable medication reminder and dispensing system

(76) Inventors: Stephen Richard Soled, Westwood, NJ (US); Alan Edward Kaplan, Morris Township, NJ (US); Edward M. Ulicki, Upper Saddle River, NJ (US)

Correspondence Address: ABELMAN, FRAYNE & SCHWAB, 666 THIRD AVENUE, 10TH FLOOR, NEW YORK, NY, 10017, US

(21) Appl. No.: 11/337,066

(22) Filed: Jan. 19, 2006

Related U.S. Application Data
(60) Provisional application No. 60/664,946, filed on Mar. 25, 2005.

(51) Int. Cl. G04B 47/00; G04C 21/00; G04B 23/02

(52) U.S. Cl. 368/10; 368/73

(57) ABSTRACT

An integrated medication reminder apparatus for providing audible reminder messages at predetermined times includes a clock means for generating real time signals, a voice recorder/playback means for recording and playing voice reminder messages, a sleep-mode means for generating a communications signal for communication with a secondary communications device, and an acknowledgement means for generating acknowledgement signals. A controller receives the real time signals and communications signal, establishes communications with the secondary communications device, instructs the voice recorder/playback means to send and play the reminder messages at the secondary communications device at predetermined times, and initiates a phone call to a designated care-giver via a locally connected telephone, in the absence of an acknowledgement signal after a voice reminder message has been played, and optionally, if removable a pill box of a pill dispenser coupled to the reminder apparatus is not removed and reinserted in a timely manner.

### CROSS REFERENCE TO RELATED APPLICATIONS

This application claims priority to provisional patent application Ser. No. 60/664,946, filed Jan. 19, 2005, the disclosure of which is incorporated herein by reference.

### FIELD OF INVENTION

The present invention generally relates to a medication dispensing apparatus, and more specifically to an apparatus that dispenses medication, monitors compliance with a medication regime, and provides medication alerts.

### BACKGROUND OF THE INVENTION

When medications are prescribed, a patient frequently does not follow the administration instructions included with the medication. A patient often forgets the specific time of day that the medication should be taken or miscalculates the interval between doses which results in the patient taking medication too frequently, too infrequently or not at all. This can lead to a variety of pharmacological and/or toxicological problems to the patient that ultimately may result in ineffective treatment of a disease and/or harm to the patient.

Frequently, patients who need to take several different medications during the course of a day, become confused both with the frequency and the particular medication that needs to be taken at a particular time resulting in the above problems. These problems are compounded when the patient has impaired eyesight or is in a confused state of mind.

Whereas past systems have provided patient-programmable reminder systems, these systems do not address the needs of those patients, who, through a lack of manual dexterity, impaired eyesight or inability to follow written or oral instructions are either incapable of or unwilling to use these reminder devices. These reminder devices may also permit the patient to attempt to program a device, which can lead to inappropriate reminders or frustration with the device due to the complexity of the programming task whereby the device is disregarded and not used. Furthermore, past devices may enable tampering by unauthorized individuals which again may lead to inappropriate reminders.

In some situations, if the patient fails to acknowledge a medication reminder message, the reminder device contacts, illustratively by telephone, a personal emergency response system (PERS) monitoring center. The PERS is typically administered by a central office, where designated response personnel will attempt to call the patient to determine why the patient has not taken his/her medicine at the designated time. The patient may have not heard the message from the medication reminder device, an emergency situation may have occurred, or some other situation may have occurred that prevented the patient from taking the medication. In any event, personnel of the PERS have undertaken the responsibility to follow-up with the patient in the event that the patient has missed taking their medication in a timely manner.

Although the relationship between many patients and a personal emergency response system is convenient, the costs of such services may appear to be high to some patients, especially those with fixed incomes. As such, there is a need in the art to provide a low cost medication reminder device that alerts users to take their medications at predetermined times, and that can call a caregiver in the event that the patient fails to take the medication in a timely manner.

### SUMMARY OF THE INVENTION

The disadvantages heretofore associated with the prior art are overcome by the present invention of a medication reminder apparatus for providing voice reminders messages at predetermined times. The medication reminder apparatus includes a clock means for generating real time signals, a voice recorder/playback means for recording and playing voice reminder messages, a sleep-mode means for generating a communications signal for communication with a secondary communications device (e.g., cell phone), and an acknowledgement means for generating acknowledgement signals.

A programmable controller and memory means receives the real time signals and communications signal, establishes communications with the secondary communications device, and instructs the voice recorder/playback means to play the reminder messages at the secondary communications device at predetermined times. In response to failing to receive an acknowledgement signal from the secondary communications device after a voice reminder message has been played for a predetermined period of time, the controller initiates a phone call to a designated care-giver via a local telephone coupled to the controller.

Optionally, a pill dispenser having a plurality of pill compartments for storing medicine is communicably coupled to the reminder apparatus. The proper pill compartment must be removed from and reinserted back into the pill dispenser, and an acknowledgement signal must be provided from the reminder device, in response to the reminder message within a predetermined time to prevent calling of one or more care-givers.

### BRIEF DESCRIPTION OF THE DRAWINGS

The teachings of the present invention can be readily understood by considering the following detailed description in conjunction with the accompanying drawings in which:

FIG. 1 is a rear perspective view of a medication reminder and pill dispenser system of the present invention;

FIG. 2 is a top perspective view of the medication reminder of FIG. 1;

FIG. 3 is a schematic block diagram of control circuitry for operating the medication reminder;

FIG. 4 depicts a block diagram of a first embodiment of a pill dispenser suitable for use with the medication reminder device; and

FIGS. 5A, 5B and 5C collectively depict a flow diagram of a first method of reminding and dispensing medications to a patient.

To facilitate an understanding of the invention, the same reference numerals have been used, when appropriate, to designate similar elements that are common to the figures. Unless stated otherwise, the features shown and described in the figures are not drawn to scale, but are shown for illustrative purposes only.

### DETAILED DESCRIPTION OF THE INVENTION

The present invention is a medication reminder device and pill dispenser system for reminding people, such as elderly or disabled patients, to take their prescribed medications at predetermined times. The medication reminder device has recorded voice reminder messages, preferably recorded in the voice of a loved-one, that play over a speaker to the patient at predetermined times to remind the patient, illustratively, that it is time to take their medicine.

The patient must acknowledge the voice reminder message, illustratively, by pressing a blinking acknowledgement button. In the event that a patient fails to take the prescribed medication (e.g., by removing from and reinserting a bill box into a pill dispenser) or press the acknowledgement button within a predetermined time, one or more reminder additional messages are played. If, after the additional reminder messages are played, or after a predetermined time has elapsed, the medication reminder device automatically calls a secondary communications device (e.g., a cell phone, local phone or any other designated communication device) designated by the patient to instruct the patient to acknowledge receiving the reminder message via the secondary communication device. If the patient fails to provide an acknowledgment signal (e.g., the patient fails to answer his/her cell phone), the medication reminder will automatically telephone a designated phone number of a primary care-giver who can initiate a personalized contact routine with the patient. If the primary care-giver is not available, secondary designated phone numbers (e.g., of the primary care-giver or a secondary designated care-giver) are sequentially called over the telephone based on their availability.

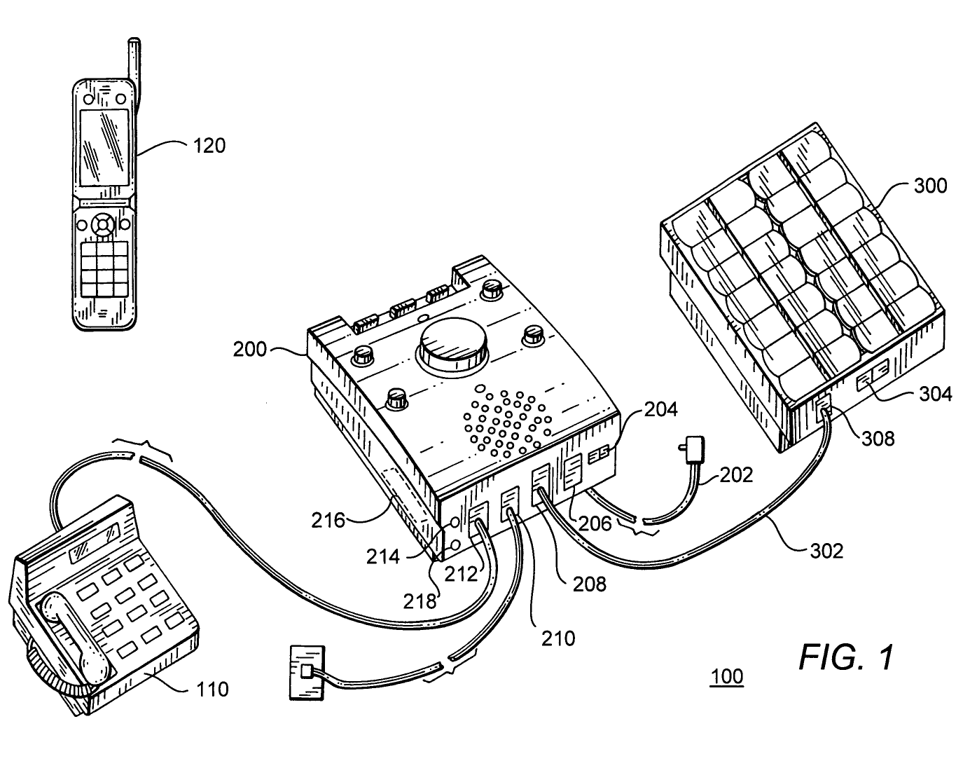

Referring to FIG. 1, the system 100 comprises a medication reminder device 200 that is electrically coupled to a pill dispenser 300 and a telephone 102. The reminder device 200 is operable with a conventional wired telephone, and optionally the pill dispenser 300, among other optional accessories, such as a wireless receiver for receiving wireless communications from a mobile pendent with a transmitter, a display screen, or other accessories.

The medication reminder device 200 includes a power line 202, illustratively, with an in-line power supply (12 volts) suitable for use in a conventional 120 volt wall outlet where the patient resides. Preferably, power to the reminder device 200 is provided by merely plugging the power line 202 into the wall socket without the use of power switch. In this manner, the reminder device is always on, unless it is physically unplugged from the wall outlet. However, optionally, a power (on/off) switch 204 can be provided, illustratively, located on the rear portion of the reminder device.

A plurality of input/output ports, such as an accessory port 206 (e.g., RJ48 jack), a pill dispenser port 208, a phone line port 210 (e.g., RJ11 jack), a phone port 212 (e.g., RJ11 jack), a reset button 214, and an audio jack 218 are also illustratively positioned on the rear portion of the medication reminder device 200. The message reminder 200 is coupled to the telephone 110 via conventional telephone wiring and optionally to the pill dispenser 300 via a multi-wire cable suitable to transfer information there between.

The pill dispenser 300 includes an I/O port 308 for receiving electrical power from the reminder device 200 to the pill dispenser 300 via cabling 302. The cabling 302 also provides bi-directional communications signals between the medication reminder device 200 and pill dispenser 300. Additionally, the medication reminder device 200 is provided with batteries 216 (drawn in phantom) in the event a power outage occurs where the patient resides (e.g., the patients home). If a power outage lasts more than a predetermined time (e.g., 20 minutes) the reminder device 200 automatically calls the designated caregiver with an alert message.

The telephone 110 can be any conventional telephone capable of sending and receiving telephone calls via telephone wiring (e.g., twisted pair) where the patient resides. The telephone 110 forwards a phone call initiated by the message reminder device 200 to a designated care-giver, such as a child, another relative, or friend of the patient. The telephone 110 can also be used to receive a remote telephone call from the care-giver to program the medication reminder 200 to dispense the medication at a particular time, or to contact the patient in a conventional manner, such as to inquire why the patient failed to take the medication at a particular time, as discussed below in greater detail.

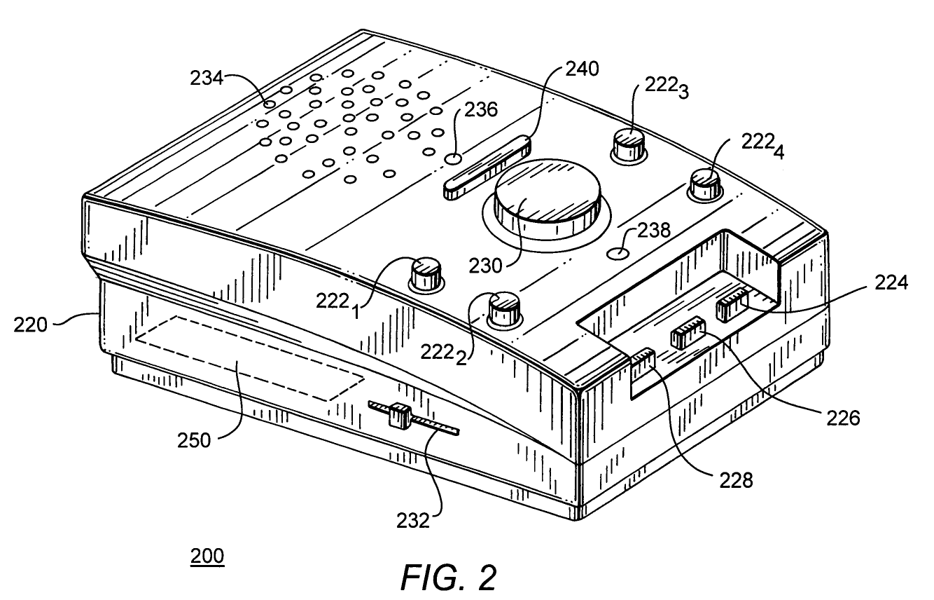

Referring to FIG. 2, a top perspective view of the medication reminder device 200 is shown. The medication reminder device includes a housing 220 that facilitates various control circuitry 250 (drawn in phantom), and a plurality of user interface devices, such as switches and/or buttons that enable or disable various features of the device 200, as well as a plurality of lights that illuminate under various circumstances, both of which are discussed below in further detail. Preferably, the housing 220 is manufactured from polyvinyl chloride (PVC) or other plastic materials by injection molding, although the fabrication materials and techniques are not considered as limiting.

In particular, the medication reminder device 200 includes a plurality of speed-dial buttons, such as speed-dial buttons 222₁ through 222₄, a remote programming switch 224, a sleep mode switch 226, a local programming switch 228, and an acknowledgement button 230. The medication reminder device 200 also includes a volume-control interface 232, a speaker 234 (and audio jack 218 for connecting external speakers), a system warning light 236, a sleep mode “on/off” light indicator 238, and a system check and time switch 240. The plurality of user interface devices are described in terms of their function, as well as their preferable shapes, colors, and other characteristics, however such user interface device characteristics are not considered as being limiting.

In one embodiment, the medication reminder includes four speed-dial buttons, although the number of speed-dial buttons is not limiting. Preferably, the four speed-dial buttons are opaque and color-coded to facilitate identification. Each speed-dial button can be programmed with a specific telephone number to assist the patient in quickly contacting a designated persons or entities. Preferably, speed-dial button 222₁ is colored red and is programmed to dial 911 for emergency situations; speed-dial button 222₂ is colored green and is programmed to dial the patient's local pharmacy; speed-dial button 222₃ is colored light blue and is programmed to dial the patient's primary care-giver; and speed-dial button 222₄ is colored white and is programmed to dial the patient's primary doctor. Preferably, 911, pharmacy, care-giver, and doctor labeling is also provided on the top cover proximate the speed-dial buttons. Accordingly, the speed-dial buttons 222 allow the patient to expedite a call to a particular person or entity based on their immediate needs.

One skilled in the art will recognize that the speed-dial buttons 222 can be programmed with any number suitable to accommodate the user's needs. For example, the speed-dial button 222₁ can alternatively be programmed with the telephone number of the local police or other emergency response organization in the event 911 emergency coverage is not available. If the patient presses speed-dial 222₁, the reminder device 200 will also alert the designated caregivers with an automated message that an emergency call was made. In one embodiment, the medication reminder device 200 can be set to call the care-giver approximately 20 minutes after the patient makes the 911 call. In this manner, the patient's telephone line remains clear so that the emergency personnel who are sent in response to the 911 call can contact the patient, if necessary.

The message acknowledgement button 230 is used by the patient to acknowledge that his/her medication has been taken in a timely manner. That is, once a pre-recorded voice message is given at a particular time interval to remind the patient to take certain medication, the patient must acknowledge the voice message within a predetermined time by pressing the acknowledgement button 230. Preferably, the acknowledgement message button 230 is translucent, yellow or orange in color, and has a large diameter of at least 1.6 inches (40 mm). In one embodiment, positioned beneath the acknowledgement button 230 is one or more light emitting diodes (LEDs), which blink at a predetermined interval once the medication reminder voice message is played through the speaker 234 to the patient.

There may be instances where the patient is away from the medication reminder device 200 and not hear or clearly hear the voice reminder message. The blinking LED provides an alternative sensory mechanism that assists in letting the patient know that it is time to take their medication and they must timely acknowledge the reminder message that was played. Once the patient takes the medication and presses the acknowledgement message button 230, the LED stops blinking and turns off, until the next voice reminder message is played.

The sleep mode button 226 is used by the patient to turn the reminder messages off in an instance where the patient expects to be away from the place where the medication reminder device 200 resides for time when at least one reminder message would be played. That is, once a pre-recorded voice message is given at a particular time interval to remind the patient to take certain medication, the patient must acknowledge the voice message within a predetermined time by pressing the acknowledgement button 230. The sleep mode button disables the voice message playback feature of the reminder device 200.

Preferably, the sleep mode button 226 is translucent, dark blue in color, and rectangular in shape. Alternatively, the sleep mode button 226 can be opaque, and a separate LED 238 is positioned adjacent to the sleep mode button 226.

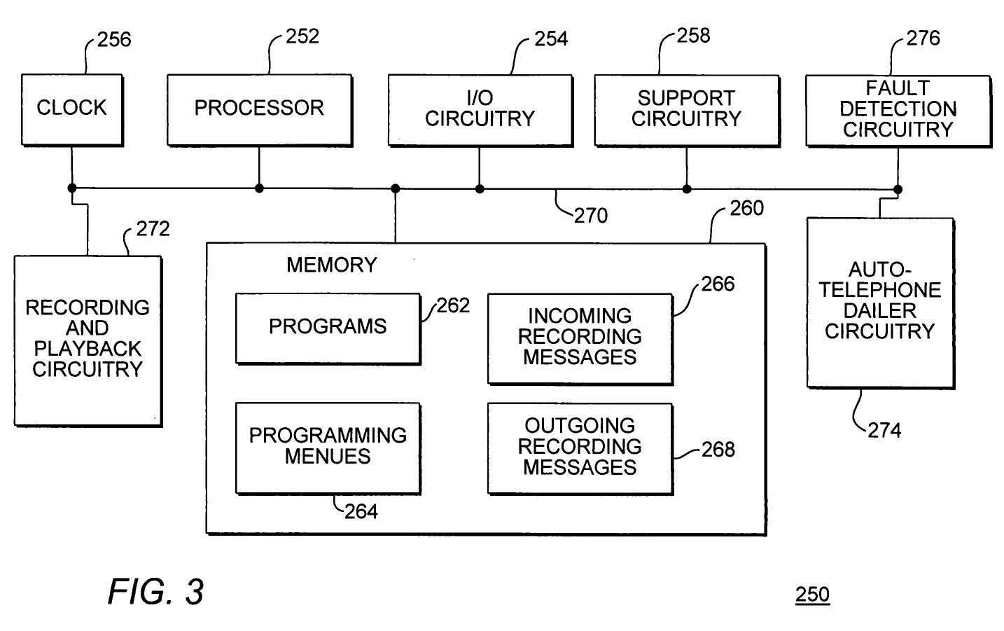

In one embodiment, positioned beneath the sleep mode button 226 is a LED, which blinks at a predetermined interval once the sleep mode button 226 is pressed to indicate “sleep” mode of operation. Pressing the sleep button 226 also sends an automated alert message by telephone to the designated care-givers to alert them that the reminder device 200 has been switched to the sleep mode. When the patient returns, the patient presses the sleep mode button 226, which turns on the voice message reminder program and turns off the blinking LED. An automated alert message is sent by telephone to the designated care-givers to alert them that the reminder device 200 has been switched to the normal mode of operation. It is noted that even though the medication reminder 200 is set in a sleep mode of operation, a clock circuit 256 (FIG. 3) maintains the current time so that the programmed voice reminder messages play at their appropriate times once the sleep mode of operation is turned off.

In a preferable embodiment, the sleep mode button 226 will trigger the automatic dialing circuitry 274 (FIG. 3) to call a preprogrammed telephone number of a secondary communications device 120 (FIG. 1). The secondary communications device 120 can illustratively be a cell phone or land-line phone associated with the user. For example, the secondary communications device 120 can be a secondary land-line phone on a different line from the local telephone 110 at the patient's residence, illustratively installed in an upstairs bedroom, pool-side, or other location at the user's residence. Alternatively, the telephone can be located at a neighbor's house or any other location.

A voice reminder message is played over the secondary communications device along with instructions to confirm receipt of the reminder message, illustratively, by pressing the star (*) key on the cell phone key pad. If the user fails to answer the phone or fails to properly confirm receipt of the reminder message, then the auto-dialer circuitry calls the designated primary phone number associated with a care-giver. Accordingly, sleep mode button 226 operating in conjunction with a secondary communications device 120 allows the user to be mobile and still receive the reminder messages. Further, the user can prevent the reminder device 200 from calling a designated caregiver by merely confirming receipt of the reminder messages.

The system check button 240 and warning light 236 operate cooperatively to provide the patient with indication of a fault occurrence. The medication reminder device 200 includes fault detection circuitry 276 (FIG. 3) to monitor for fault occurrences such as loss of AC power, low battery voltage, telephone line failure, communication problems with the pill dispenser, and various controller errors, such as FLASH memory read and write errors, or synchronization errors with external devices. If any such faults are identified by fault detection circuitry 276, the warning light (LED) 236 will illuminate. The fault detection circuitry 276 automatically monitors various fault detection points to ensure proper operation, and in one embodiment, runs a complete diagnostics checkout at predetermined intervals, such as every two minutes.

Alternatively, the patient can press the system check button 240 to initiate system diagnostics. The medication reminder will run a system check, as defined by routines stored in memory of the device 200, and state the type of fault, if any, over the speaker 234 to the patient for corrective action. If there are no faults, the warning light 236 is turned off. If a fault is detected, either by automatic detection or user initiated detection, in one embodiment, the medication reminder 200 plays a voice message over the speaker 234 to identify the cause of the fault. For example, a voice message such as “the telephone line has been disconnected;” or “the battery is low”, among others is preferably played over the speaker 234. Alternatively, the controller 250 can cause the warning light 236 to blink at certain predefined intervals to indicate a particular fault, which can be identified by the patient or care-giver by counting the number of blinks occurring and then correlating such number with a fault list illustratively provided in the owners manual to determine the fault.

In one embodiment, the patient can find out the day of the week, date and time by pressing the system check button 236. This feature is important to patients who are visually impaired or have difficulty remembering the day of week, date or time of day. The medication reminder 200 states the day, date and time to the patient over the speaker 234, and then proceeds to conduct the system check, as discussed above.

The medication reminder device 200 can be programmed either locally or remotely. The local button 228, when pressed, enables the medication reminder device 200 to be programmed locally on site. Preferably, the local button 228 is opaque, purple in color, and substantially rectangular in shape.

Pressing the local button 228 instructs the controller 250 to utilize a menu mode program that is specific for local mode of operation, and causes the telephone 110 to go off-hook. The patient or other user then removes the handset of the telephone from the telephone 110 to interface with a menu dialogue provided by the menu mode program of the medication reminder 200. That is, the local mode of operation allows the user to enter messages and interface with the medication reminder device 200 via the local telephone 200. Once the patient or user hangs up the handset, the local mode programming is terminated, and the menu mode program ends. The patient or user can then use the telephone in a customary manner. If the telephone is already off-hook, i.e., someone is using the telephone to make a phone call, and the local mode button 228 is pressed, the current telephone connection is automatically terminated, and the menu mode of operation is set to local mode, as discussed above.

Alternatively, the remote button 224 is provided to permit programming the medication reminder device 200 from a remote location. Preferably, the remote button 224 is opaque, brown in color, and substantially rectangular in shape.

Remote programming of the medication reminder 200 is performed by the patient initially receiving a telephone call, illustratively, from one of their personalized care-givers, such as a family member, friend or neighbor. The patient receives the external telephone call by removing the handset from the telephone to take the telephone off-hook. The patient then presses the remote button 224, which activates the remote menu mode program. In this manner, the patient must be contacted first to give permission to the caller to remotely program the reminder device 200.

The medication reminder device 200 establishes bi-directional communications with the telephone 110, and initiates a menu dialogue with the remote caller. The menu mode program of the reminder device 200 is turned off and the telephone line is released once the patient hangs up (goes on-hook).

A volume control lever 232 is provided, illustratively, on the side of the medication reminder device 200. The volume control lever 232 controls the volume of the voice reminder messages that a played over the speaker 234. Preferably, support circuitry 258 (FIG. 3) of the reminder device 200 includes amplifier circuitry (not shown) to ensure that the volume can be raised to levels sufficient to hear for those patients with hearing loss.

The auxiliary port 206, illustratively located on the rear panel of the reminder device 200 is provided to connect accessory products and devices, such as a remote receiver and transmitter to allow the patient to call a telephone number of their choosing while pressing a wireless pendant, a large display screen for those patients who are hearing impaired, among other accessories.

As shown in FIG. 2, the medication reminder 200 further comprises at least one controller 250 that is suitable for controlling operations of the medication reminder 200, as well as communicating with external devices, such as the telephone 110 and pill dispenser 300. Specifically, the controller 250 comprises at least one processor 252, as well as memory 260 for storing various control programs 262, programming menus 264, incoming messages 266 and outgoing messages 268. The processor 250 may be any conventional micro-controller or processor, such as one or more INTEL or MOTOROLA processors.

The memory 260 may comprise volatile memory (e.g., RAM), non-volatile memory (e.g., flash memory, PROMS, disk drives and the like) and/or a combination thereof. The processor 250 cooperates with clock circuitry 256 and support circuitry 258, such as power supply circuitry, cache memory, amplifier circuitry, among other conventional support circuitry, to assist in executing software routines stored in the memory 260. Communication or exchange of information is provided between the various controller components via one or more bus lines 270. The controller 250 also comprises input/output (I/O) circuitry 254 that forms an interface between various functional elements communicating with the controller 250. The I/O circuitry 254 interfaces with the processor 252, memory 260, and other controller components via bus 270.

For example, as shown in FIG. 1, the exemplary controller 250 communicates with the telephone 110 via phone line utilizing conventional RJ11 4-pin connectors. Further, the controller 250 can communicate with the optional pill dispenser 300 via multi-wire cabling using conventional RJ48 10-pin connectors.

It is contemplated that some of the process steps discussed herein as software processes may be implemented within hardware, for example, as circuitry that cooperates with the processor 250 to perform various steps. Further, although the controller 250 of FIG. 3 is depicted as a general-purpose computer that is programmed to perform various control functions in accordance with the present invention, the invention can be implemented in hardware such as, for example, an application specific integrated circuit (ASIC). As such, it is intended that the processes described herein be broadly interpreted as being equivalently performed by software, hardware, or a combination thereof.

The clock 256 is preferably a crystal clock that accurately keeps the time of day, although other clock circuits can be utilized. In one embodiment, the reminder device 200 periodically initiates a telephone call to a service provider that provides the time of day over the telephone. Alternatively, a GPS system or radio receiver for receiving National Institute of Standards and Technology (NIST) time broadcasts can be provided in the reminder device 200 to maintain time or receive periodic time updates. In this manner, the reminder device 200 accurately maintains the time of day.

Referring to FIG. 3, recording circuitry 272 is provided to record digital messages, as well as play recorded messages at specified times to remind the patient of important tasks, such as taking medication. Multiple messages can be recorded and programmed to play daily, every other day, once a week, once a month or on specific days at prescribed times. The messages repeat nearly on a continuous basis for a predetermined time (e.g., 20 minutes) or until the acknowledgement button is pressed. Messages can also be recorded to be telephoned to designated telephone numbers.

The reminder device 200 includes a menu program stored in memory 262, which is executed by the processor 252 in response to pressing either the local programming button 228 or the remote programming button 224 (when being programmed remotely). In either case, the menu program initiates a series of voice prompts stored in memory 260 that direct the person programming the device 200 to record a message or press a particular number on their telephone keypad.

Many different types of customized messages can be recorded for playback on the reminder device 200, such as messages to remind the user to take medications and initiate safety-related actions (e.g., lock doors before bedtime, schedule a doctor's appointment, reorder prescriptions, pay bills, etc.). Preferably, the messages are recorded by a voice that the patient is familiar with to provide a friendly reminder, as well as avoid startling the patient with a non-familiar voice. In one embodiment, music or other sounds can be played to get the patient's attention prior to playing the voice message, such that, for example, a music clip is played followed by or along with the voice reminder message.

The recorded messages and other functions (adjusting volume, entering auto-dial telephone numbers, alerting the device which diode lights are to be operational, etc.) are controlled by the controller 250 and initiated by pressing keys on a directly connected or remotely located telephone key pad. Pre-recorded verbal directions initiated for playback by the program menus stored in the memory 262 of the reminder device 200 clearly explain how to setup and program the device.

The controller also includes automatic telephone dialer circuitry 274 that initiate dialing of one or more predetermined phone numbers corresponding to one of the speed-dial buttons being pressed, or because of a failure to acknowledge receiving a voice reminder message in a timely manner. The dialer circuitry 274 communicates with the processor 252, memory, support circuits 258 and other components of the controller 250 via the bus lines 270. The auto dialer circuitry 274 is capable of detecting call-progress tones (i.e., dial tones, busy signals and the like), as well as generating standard touch-tone signals for initiating a telephone call.

The reminder device 200 will always play its messages at the prescribed day and time because the recorder player is integrated with an internal battery powered clock and battery backup. Optionally, a battery pack can be provided to ensure that power interruptions will not adversely affect playback at the precisely scheduled time. If the batteries are low in power, the device's time/check diode light 236 blinks, and when the time/check button 240 is pressed, the device 200 tells the user to “check the batteries.”

The patient confirms receipt of the played message by pressing the acknowledgement button 230 that starts to blink as the related message is played. If the acknowledgement button is not pressed, the message repeats itself, for example, with a seven second time delay between messages for a specified time (e.g., 20 minutes) until the acknowledgement button 230 is pressed. Optionally, for the first 15 minutes, the message plays at the selected volume level. Since the user may be in a different room and did not hear the message, during the final 5 minutes of the specified time, the device switches to its highest volume level.

The patient programs the telephone numbers of designated care-givers who are to be automatically alerted if the confirmation button is not pressed. If the acknowledgement button is not pressed after the message has been played for a specified time (e.g., 20 minutes), a telephone auto-dialer automatically calls the first (primary contact) telephone number that the patient has programmed into the reminder device. This could be the number of a relative, friend, neighbor, among other persons to alert the designated person that the acknowledgement button 230 was not pressed.

The auto-dialer 274 delivers a prerecorded message from memory 268 to the care-giver, such as, “This is an automated alert message. The user (e.g., patients name inserted here) has not acknowledged a reminder message played at (time and day). Please check on the user's wellness. To confirm receipt of this message, please press the star (*) key on your telephone keypad.”

If the called care-giver does not press the star (*) key, the call is terminated and the medication reminder device rolls over to call a designated secondary phone number. That is, if the first designated telephone number is busy, not answered, answered by an answering machine, or no confirmation signal is provided by the primary care-giver, then the reminder device 200 will sequentially dial alternate programmed “rollover” telephone numbers. In one embodiment, the phone numbers of six care-givers can be stored in a hierarchal order in the memory of the reminder device 200.

To facilitate medication compliance, a compliance-sensing pill-dispenser 300 is also part of the present invention. This pill dispenser 300 is communicably coupled to the reminder device 200 via cabling 308 to exchange signals.

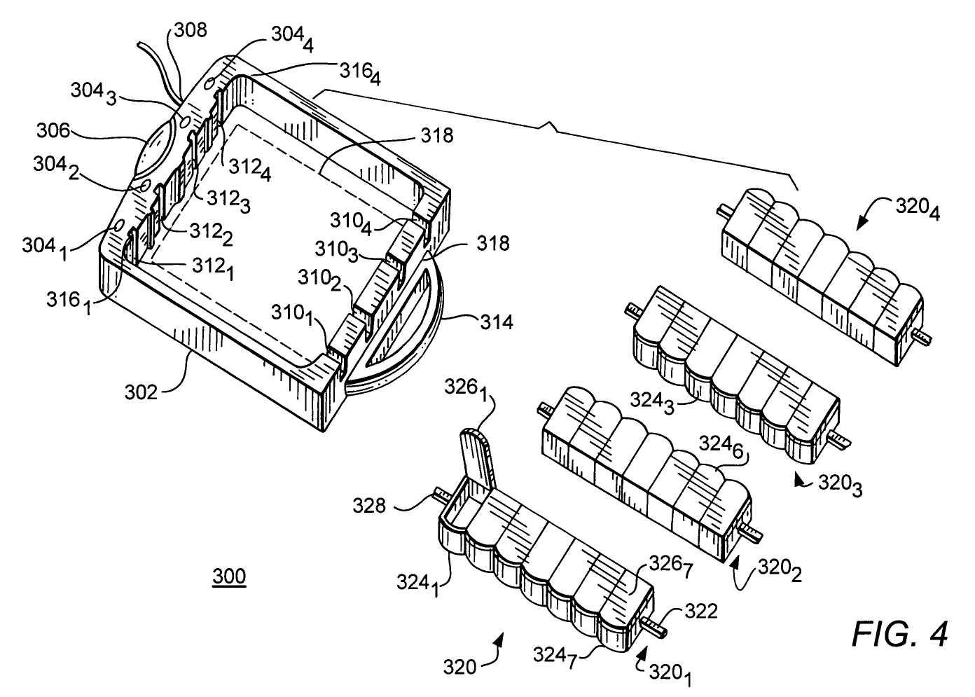

FIG. 4 depicts a top perspective view of a first embodiment of the pill dispenser 300 suitable for use with the medication reminder device 200. In a preferred embodiment, the pill dispenser 300 includes a housing 302 shaped as a semi-rectangular tray and sized to receive four pill box holders 320₁ through 320₄ (collectively pill box holders 320). Preferably, the housing 202 is manufactured from polyvinyl chloride (PVC) or other plastic materials by injection molding, although the fabrication materials and techniques are not considered as limiting. Each pill box holder 320 includes seven compartments 324₁ through 324₇ (collectively pill compartments 324) having seven corresponding lids 326₁ through 326₇ (collectively compartment lids 326) that can be opened and closed to respectively remove and seal the medication.

The four pill box holders 320 can be used for storing medication that is to be taken in the morning, noon, dinner time, and bedtime for the seven days of the week. Thus, medication for the entire week can be stored in the compartments 324 according to the day and time the medications are to be taken by the patient. For example, compartment 324₁ of pill box 320₁ stores medicine to be taken on Monday in the morning, compartment 324₆ of pill box 320₂ stores medicine to be taken on Saturday at noon, compartment 324₃ of pill box 320₃ stores medicine to be taken on Wednesday at dinner time, and so forth.

In one embodiment, the compartments associated with a pill box can be sized differently from the compartments associated with another pill box. For example, many patients take more medicines in the morning than at dinner time. Accordingly, the compartments of pill box 320₁ can be fabricated larger than the compartments of pill box 320₃.

Each pill box 320 includes a lifting tab 322 and an alignment boss 328 that are formed on opposing ends and axially aligned along the length of the pill box 320. Preferably the alignment bosses 328 are keyed to prevent insertion of the wrong pill box into the wrong slot. The lifting tabs 322₁ through 322₄ serve as a handle to enable the patient to remove and insert the pill box in the housing 302. The housing 302 includes four grooves 310₁ through 310₄ formed in a sidewall sized to receive the lifting tabs 322.

The bosses 328₁ through 328₄ align the pill boxes 320 in the housing 302 by sliding into a corresponding channel 312₁ through 312₄ formed along an opposing sidewall of the grooves 310. In one embodiment, each channel 312 includes a switch 316₁ through 316₄ that is used to sense whether the pill box has been removed from or inserted into the housing 302. As shown in FIG. 4, pill box 320₁ can be inserted into and removed from a first slot formed by channel 312₁ and opposing groove 310₁, pill box 320₂ can be inserted into and removed from a second slot formed by channel 312₂ and opposing groove 310₂, and so forth.

In one embodiment, the switches 316 are optical switches capable of producing an electrical signal in response to removal or insertion of the bosses 328, although other switch types can be used, such as mechanical (e.g., spring metal) switches, among other types of conventionally known switches. The switches 316 are electrically connected to the cabling 308 between the pill dispenser 300 and reminder device 200 to enable the reminder device to detect the removal or insertion of a pill box 320 from or into the pill dispenser. Optionally, the switches 316 can be electrically coupled to a warning light 306, which will illuminate (e.g., red) when the pill box 320 is not replaced in a timely manner, as discussed below.

The housing further includes alert lights 304₁ through 304₄ that are positioned on the upper surface of the housing 302 proximate a corresponding channel 312 associated with a pill box 320. For example, a green LED 304₁ is positioned near channel 312₁, green LED 304₂ is positioned near channel 312₂, and so forth. Preferably, the LEDs 304 are illuminated by the switches 316 when the corresponding pill boxes 320 are inserted in the housing 302. The illumination of the LEDs 304 permits the patient to ensure that they have properly placed the pillboxes 320 in the housing.

When it is time for the patient to take his/her medicine, the reminder device 200 plays the recorded voice reminder message and the acknowledgement button 230 blinks on and off. Further, the medication reminder device 200 sends a signal to the pill dispenser 300, if present, to cause one of the green LED 304 (associated with the time of day) to blink on and off to indicate the corresponding pill box 320 that should be removed to retrieve the proper medication. For example, if the time of day is 8:00 am, then the reminder device 200 send a signal to the LED 304₁ to cause it to blink on and off. If the time of day is 12:00 pm, then the LED 304₂ will blink on and off. Similarly, if the time of day is 6:00 pm, then the LED 304₁₃ will blink on and off, and if the time of day is 10:00 pm, then the LED 304₄ will blink on and off.

The patient removes a pill box 320 by grasping and lifting the lifting tab 322 to remove the appropriate pill box 320 from the housing 302. Once a pill box 320 is remove from the housing 302, the corresponding LED 304 stops blinking and turns off. Further, the medication reminder device 200 senses that the pill box 320 has been removed.

Preferably, each compartment lid 326 is labeled with the day of the week. The patient can then open the appropriate lid 326 of the compartment 324 corresponding to the day of the week and the time of the day to take the prescribed medication. In one embodiment, the pill dispensers 320 are color coded to provide further indication of the appropriate pills to consume. For example, a yellow pill box can be dedicated for the morning medications, a blue pill box can be used for the afternoon medications, and so forth.

In one embodiment, the patient must consume the allotted medication and place the removed pill box 320 back into the housing within a predetermined time. Once the patient has properly inserted the pill box back into the housing 302, the warning light 306 will turn off. The patient must then press the confirmation button 230 on the reminder device 200 to prevent automatic calling to the care-giver.

If the user fails to consume the medication and return the pill box 320 back to its proper slot in the housing 302 within the predetermined time (e.g., 3 or 4 minutes), the red warning light 306 will illuminate to notify the patient that the pill box has not been returned in a timely manner. One skilled in the art will appreciate that the speaker 234 mounted in the housing 220 of the reminder device 200 can be used to produce an audible signal, such as a tone that plays for 2-4 seconds, in instances when the warning light 306 is illuminated.

Furthermore, the pill dispenser 300 sends a signal indicating non-compliance to the medication reminder device 200 via output port and cabling 308. The non-compliance signal is sent to the reminder device 200 even if the patient presses the confirmation button 230. In response, the reminder device 200 plays a message, such as “please return you pill box to the pill box holder.” This reminder message is played up to a predetermined time, such as for two minutes. If the patient fails to insert the pill box 320 back into the pill dispenser, as well as press the confirmation button 230 within the allotted two minutes, then the automatic dialing circuitry 274 of the reminder device 200 automatically calls the designated care-giver in the manner described above with respect to FIGS. 1-3.

Accordingly, at the appropriate time the reminder device 200 repeats the reminder message until twenty minutes has elapsed from the time when the patient was initially supposed to take the medication, although such time is not limiting. Thus, the patient must properly insert the pill box 320 back into the housing 302, as well as press the confirmation button 230 on the medication reminder device within the predetermined time constraints. Otherwise, the reminder device 200 will initiate a telephone call to the designated care-giver.

In a preferred embodiment, a medication list panel 314 is provided to assist the patient and care-givers in identifying the medications that are stored in the pill compartments 324. The medication list panel 314 is inserted into a channel 318 (drawn partially in phantom) that extends along the bottom portion of the pill dispenser housing 302. The medication list panel 314 is preferably a flat rectangular panel and includes a handle on one end for removing and inserting the panel 314 from and into the channel 318. Labels can be provided to allow the patient or care-giver to write down the medications and associated days and times that the medicines are to be taken by the patient, and stick them on the panel 314. In this manner, a list of medications the patient is currently taking for a particular week are kept in close proximity to the pill dispenser 300 in case questions arise.

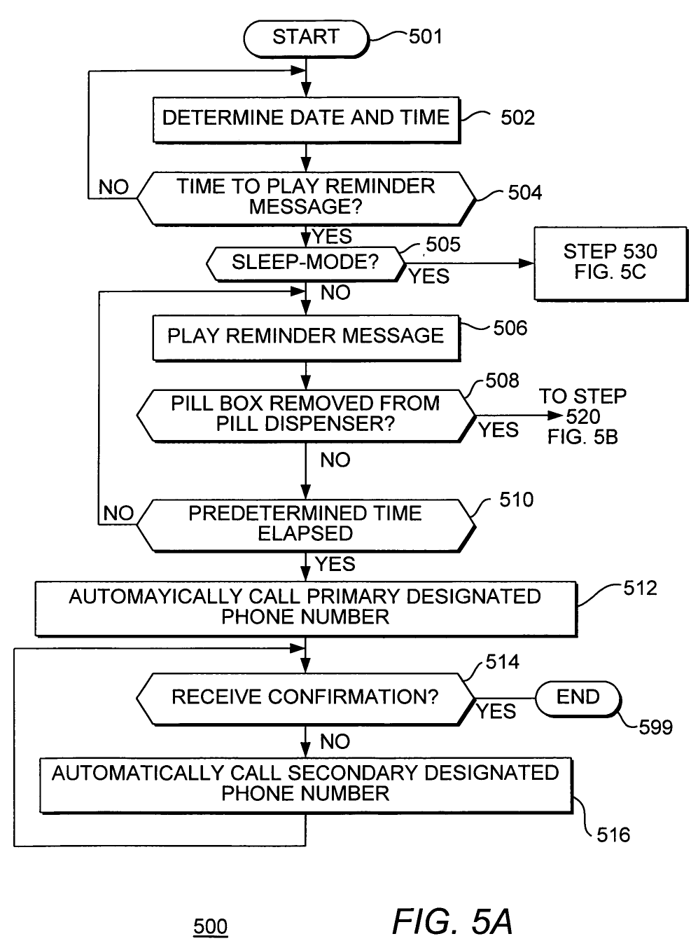

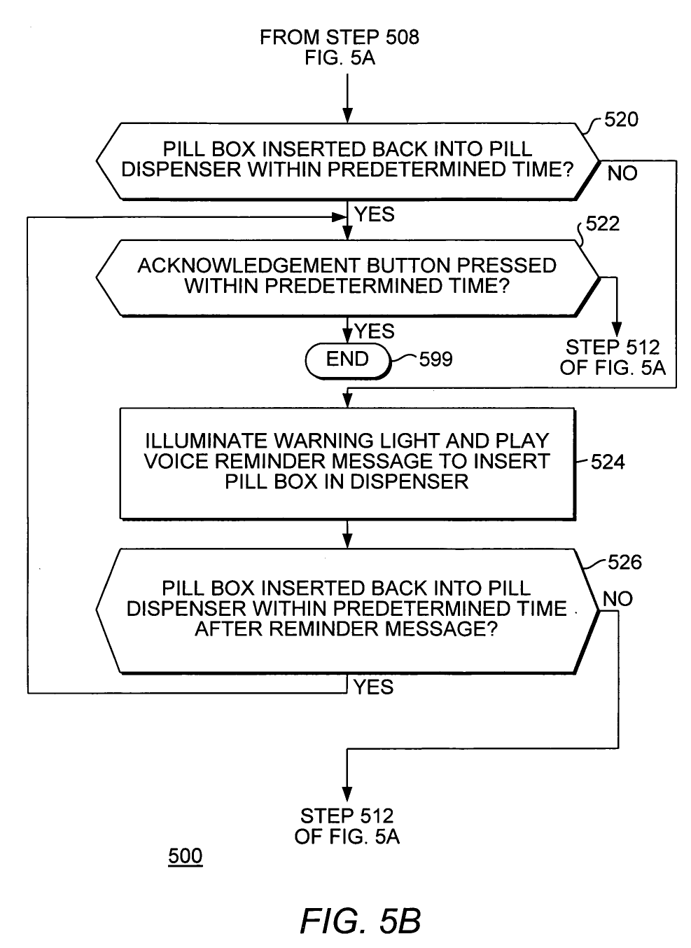

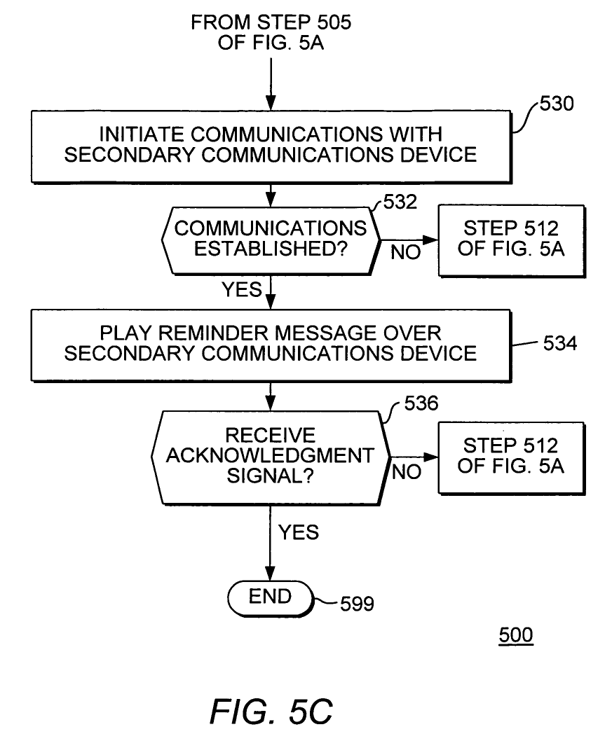

FIGS. 5A and 5B collectively depict a flow diagram of a method 500 of reminding and dispensing medications to a patient. The method 500 starts at step 501, where in one embodiments the reminder device 200 detects whether an accessory device, such as the pill dispenser 300 is connected thereto. The reminder device 200 has built-in circuitry capable of detecting the presence of an accessory device, illustratively using a voltage sensor to detect changes in voltage that occur when an accessory device is electrically connected to the reminder device 200 via the cable 302. At step 502, the medication reminder device 200 determines the current date and time of day. If at step 504, it is not time to play a reminder message, then the reminder device 200 continues to monitor the date and time until such time occurs. If at step 504, the reminder device 200 determine's that it is time to play a preprogrammed voice message to the patient, then at step 505, a determination is made whether the sleep-mode of operation has been activated. If at step 505, the patient has pressed the sleep-mode button 226, then the method 500 proceeds to step 530, which is discussed in detail with respect to FIG. 5C. Otherwise, the method 500 proceeds to step 506, where the voice reminder message is played over the speaker 234 of the reminder device 200.

Once the reminder message is played by the reminder device 200, at step 508, a determination is made as to whether a pill box 320 has been removed from the pill dispenser 300. If at step 508, no indication that the pill box 320 has been removed from the pill dispenser 300, then at step 510, to determine whether the patient has removed the dispenser within a predetermined time. If not, the method 500 proceeds to step 506 and repeats the reminder message to take the medication until, at step 510, the predetermined time (e.g., 20 minutes) has elapsed. At step 512, the medication reminder device 200 then auto-dials a designated primary care-giver via the patients telephone, who must respond with a confirmation, illustratively, by pressing the star (*) button on their telephone.

If at step 514, the primary care-giver provides a confirmation signal, the method 500 ends at step 599. Otherwise, if no confirmation signal is received by the reminder device 200, then at step 516, where a roll-over procedure initiates to automatically call a secondary telephone number. The reminder device 200 can be programmed with a list of phone numbers associate with one or more care-givers or other entities that are to be called in a specified order. In this manner, the roll-over feature enables a primary care-giver to be called first, illustratively, at home, then at work, then on their mobile device or to call a secondary care-giver at designated telephone numbers on the program list. The method 500 then proceeds to step 514 and continues in the loop, until either a primary or a secondary care-giver provides a confirmation signal, and the method ends at step 599.

If at step 508, the pill box 320 is removed from the pill dispenser 300, then the method proceeds to step 520 (FIG. 5B), where a determination is made whether the removed pill box 320 is inserted back into the dispenser 300 within a predetermined time (e.g., 3 minutes). At step 522, if the pill box 320 is timely inserted in the dispenser 300, then a determination is made whether the acknowledgement button 230 is pressed within a predetermined time, for example, twenty (20) minutes from playing the initial reminder message or two (2) minutes after the pill box 320 is inserted back into the dispenser 300. If the acknowledgement button 230 is timely pressed, then the method ends at step 599. Otherwise, the method proceeds to step 512 (FIG. 5A) where the automatic dialing to the care-giver is performed.

If at step 520 the bill box 320 is not timely inserted back into the dispenser 300, then at step 524 a warning light 306 illuminates on the pill dispenser 300, and a signal is sent from the pill dispenser 300 to the reminder device 200 indicating non compliance. The medication reminder device 200 then plays a reminder message with instructions to insert the pill box 320 back into the pill dispenser 300.

At step 526, a determination is made whether the pill box 320 is inserted back in the pill dispenser 300 within a predetermined time (e.g., three minutes) after the reminder message is played. If the pill box 320 is inserted within the predetermined time after the reminder message is played, the method 500 proceeds to step 522, where the determination whether the acknowledgement button 230 has been timely pressed. Otherwise, the method 500 proceeds to step 512 (FIG. 5A), where the primary care-giver is automatically called over the patients telephone 110. Accordingly, the program routines stored in the memory 260 of the medication reminder device 200 interact with other features of the reminder device 200, the pill dispenser 300 and the telephone 110 to ensure that the patient receives a reminder message to timely take their medication, warnings and instructions for failing to do so, and as a last resort, automatically placing a telephone call to a care-giver designated by the patient.

Preferably, the medication reminder device 200 controls the communications between the accessory devices, such as the pill dispenser 300. That is, the controller 250 of the reminder device 200 is capable of sensing when a pill box is removed from or inserted into the pill dispenser 300, count if the predetermined times have elapsed, and send the appropriate indicator signals (light indicator signals) to the pill dispenser. In this manner, the manufacturing and maintenance costs of the pill dispenser are minimized. Alternatively, the pill dispenser can be provided with controller circuitry to enable it to determine when a pill box 320 has been removed or inserted, count time and determine if a predetermined time has elapsed, as well as communicate such information to the controller 250 of the reminder device 200.

Referring to FIG. 5A, if at step 505 the patient has pressed the sleep mode button 226, then the method 500 proceeds to step 530 of FIG. 5C. At step 530, the reminder device 200 initiates communications with a designated secondary communications device 120. For example, the reminder device can be programmed with the telephone number of the patient's cell phone, a second land-line telephone number, such as a neighbor's telephone number, or any other designated number where the patient can readily access the secondary communications device 120. At step 532, a determination is made by the controller 250 whether communications with the secondary communications device 120 have been established.

If at step 532, communications have not been established with the device 120, illustratively, because the device 120 is busy or turned off, then the method 500 proceeds to step 512, where the designated primary telephone number of a care-giver is called. One skilled in the art will appreciate that the reminder device 200 can attempt to contact the secondary communications device 120 a predetermined number of times and/or for a predetermined duration (e.g., 5 times in 10 minutes) prior to calling the care-giver.

Alternatively, if at step 532 communications with the secondary communications device 120 are established, then at step 534 the reminder message is played over the communications device 120. At step 536, a determination is made whether the patient sent an acknowledgement signal to confirm receipt of the reminder message. If not, then the method 500 proceeds to step 512 to call the primary care-giver, as discussed above. Otherwise, the method 500 ends at step 599. In this manner, the patient can receive their reminder messages while being mobile, without having to worry about the reminder device 200 automatically calling the care-giver(s).

The present invention provides a medication reminder device and optional pill dispenser that can be used by a patient in their home or residence in conjunction with their local telephone Accordingly, telephone calls to a third party service provider that administers care-giving duties in response to the patient failing to acknowledge taking the medication can be reduced or eliminated entirely. The patient can purchase the medication reminder device and optional pill dispenser without having to depend on the services provided by the third party service provider, thereby reducing or eliminating administrative service fees. Additionally, the patient can designate there own personalized care-givers who will respond if they are unable to acknowledge a reminder message to take the medicine at the appropriate time.

One skilled in the art will appreciate that the substantially rectangular shape of the reminder device 200 and pill dispenser 300 are preferable, but not limiting. For example, the pill dispenser 300 can be circular in shape and include a carrousel for dispensing the pills at predetermined times. Further, the positioning of the buttons and ports on the reminder device and pill dispenser are for illustrative purposes only. In one embodiment, a protective cover can be provided over the remote button 224, sleep-mode button 226 and local button 228 of the reminder device 200 or the housing of the pill dispenser.

Although various embodiments that incorporate the teachings of the present invention have been shown and described in detail herein, those skilled in the art can readily devise many other varied embodiments that still incorporate these teachings.

What is claimed is:

1. An integrated medication reminder apparatus for providing audible reminder messages at predetermined times, comprising:
a clock means for generating real time signals;
a voice recorder and playback means for recording and playing voice reminder messages;
a sleep-mode means for generating a communications signal for communication with a secondary communications device;
an acknowledgement means for generating acknowledgement signals; and
a programmable controller and memory means for receiving said real time signals and communications signal, establishing communications with said secondary communications device, instructing said voice recorder and playback means to send and play said reminder messages at said secondary communications device at predetermined times, and initiating a phone call to a designated care-giver via a locally connected telephone, in the absence of an acknowledgement signal after a voice reminder message has been played.

2. The apparatus of claim 1, further comprising:
a housing for receiving said clock means, said voice recorder and playback means, said controller and memory means, a plurality of user interface devices, and a plurality of input/output (I/O) circuits.

3. The apparatus of claim 2, wherein said reminder messages include at least one of music and voice messages.

4. The apparatus of claim 2, wherein said controller and memory means further comprises an auto-dialer for periodically updating date, day and time of day information by calling a predetermined phone number associated with providing current date and time information.

5. The apparatus of claim 2, wherein said voice recorder and playback means plays a reminder message for a first predetermined time or until said controller receives a corresponding acknowledgement signal from one of said user interface devices.

6. The apparatus of claim 5, wherein one of said user interface devices providing said acknowledgement signal to the controller is a light associated with a push button switch positioned on the housing, said light being actuated to blink after said audible voice reminder message is played, and to stop blinking in response to the push button switch being pressed.

7. The apparatus of claim 5, wherein said secondary communications device is a telephone having a keypad, and one of said user interface devices providing said acknowledgement signal to the controller is a push button on the keypad of said telephone.

8. The apparatus of claim 2, wherein said one of said plurality user interface devices includes a sleep-mode switch adapted to prevent said voice recorder and playback means from playing any audible voice reminder messages over a speaker.

9. The apparatus of claim 2, wherein one of said plurality of user interface devices includes a local programming mode push button switch for selecting, from memory, a program menu associated with programming the medication reminder apparatus from said local telephone.

10. The apparatus of claim 2, wherein one of said plurality of user interface devices includes a remote programming mode push button switch for selecting, from memory, a program menu associated with programming the medication reminder apparatus from a remote telephone.

11. The apparatus of claim 2, wherein one of said plurality of user interface devices includes a plurality of programmable speed-dial push button switches for automatically calling a designated phone number via said local telephone.

12. The apparatus of claim 2, wherein one of said plurality of user interface devices includes a diagnostics push button adapted for audibly providing the current date and time via a speaker, and instructing said controller to perform a diagnostics test.

13. The apparatus of claim 1, wherein said clock means comprises one of a radio receiver, a crystal, and a global positioning system clock.

14. The apparatus of claim 2, wherein one of said plurality of I/O circuits is adapted to communicate with an electronic pill dispenser.

15. The apparatus of claim 14, wherein said pill dispenser includes a housing for receiving a plurality of removable pill compartments for storing medication associated with at least one of a particular day and time, said housing being configured for removing and inserting said pill compartments from said pill dispenser.

16. The apparatus of claim 15, wherein removal of a pill compartment from the housing actuates a switch that sends a first signal to said medication reminder apparatus, which in response, initiates a countdown for a second predetermined time.

17. The apparatus of claim 16, wherein said pill dispenser includes a warning light, and said medication reminder apparatus sends a warning signal to said pill dispenser to illuminate said warning light, in the event that said second predetermined count elapses.

18. The apparatus of claim 17, wherein said medication reminder apparatus plays a message to insert said pill compartment back into the pill dispenser after sending said warning signal, initiates a count for a third predetermined time, and automatically calls said designated care-giver in the event that said third predetermined time elapses.

19. The apparatus of claim 18, wherein said pill dispenser includes an indicator light associated with one or more pill compartments, said light indicator being illuminated when the one or more pill compartments are inserted in said pill dispenser.

20. The apparatus of claim 19, wherein said indicator light blinks on and off when one or more pill compartments are removed from said pill dispenser.
